(19) United States
(12) Patent Application Publication
(10) Pub. No.: US 2023/0056741 A1
(43) Pub. Date: Feb. 23, 2023

(54) Denture Aid System and Method

(71) Applicant: MC Wiegand, WALDPORT, OR (US)

(72) Inventor: MC Wiegand, WALDPORT, OR (US)

(21) Appl. No.: 17/406,545

(22) Filed: Aug. 19, 2021

(51) Int. Cl. A61C 13/07; A61C 13/24

(52) U.S. Cl. CPC A61C 13/0025; A61C 13/24

(57) ABSTRACT

A denture aid system includes an upper denture sponge and a lower denture sponge. The lower denture sponge includes a body having a front portion, a pair of arm portions extending rearwardly from opposing ends of the front portion, and a rear opening extending into a rear portion of the body. The upper denture sponge includes a body having a front portion, a pair of arm portions extending rearwardly from opposing ends of the front portion, and a recessed area on an upper side of the body, disposed along a rear edge of a rear portion of the body. A method of using the denture aid system includes inserting the lower denture sponge into the plate of a lower denture and inserting the upper denture sponge into the plate of an upper denture, such that the denture sponges create a suction and a more comfortable fit when wearing the dentures.

### BACKGROUND OF THE INVENTION

The present invention relates to a denture aid system and method. More specifically, the present invention provides a system and method of using a pair of denture sponges to provide an improved and more comfortable fit when wearing upper and lower dentures.

Denture appliances are designed to provide a removable replacement for teeth and the surrounding tissue in the mouth. While dentures are a useful tool, they are not without drawbacks. For example, a common type of denture includes a hard-lined material that contacts the gums of the wearer. This can cause unbearable gum pain to the point the wearer cannot chew any food utilizing the dentures. The hard material of the dentures can cause such pain that the wearer has to take them out and forgo wearing them entirely. Another drawback to dentures is that even properly fitting dentures sometimes leave a gap between the palate and the interior surface of the denture. If the denture does not create a proper seal against the gumline when installed, food particles and other material can enter the space between the denture and the palette and cause bacteria buildup, irritation, and possibly infection. In view of the above concerns, it is desirable to provide a denture aid system with upper and lower denture sponges that provide an improved, comfortable fit for the denture wearer that also prevents the buildup of unwanted material within the denture when in use.

Some devices for improving denture fit exist, in the known art. However, these devices have several drawbacks. For example, these devices typically include a thinner strip of adhesive material that extends along the denture plate. The adhesive material can wear out over time and can feel unpleasant when used in the mouth. The material also fails to expand to occupy void areas within the jaw and mouth that otherwise remain open as potential areas for bacteria and other unwanted material to collect. Further, the lack of an expansive material, linear edges, and other elements cause devices in the known art for improving denture use to be lacking and in need of improvements.

In light of the denture devices disclosed in the known art, it is submitted that the present invention substantially diverges in functional and structural elements from the known art and consequently it is clear that there is a need in the art for an improvement to existing denture aid devices, in this regard the present invention substantially fulfills these needs.

### SUMMARY OF THE INVENTION

In view of the foregoing disadvantages inherent in the known types of denture appliances and related denture aid devices now present in the known art, the present invention provides a denture aid system and method wherein the same can be utilized for adding enhanced comfort, improved hygiene, and a better fit to a typical denture appliance.

The denture aid system generally includes a lower upper denture sponge with a body having a front portion, a pair of arm portions extending rearwardly from opposing ends of the front portion, and a rear opening extending into a rear portion of the body. The lower denture sponge is configured to conform to an inner surface of a plate of a lower denture. The denture aid system also includes an upper denture sponge with a body having a front portion, a pair of arm portions extending rearwardly from opposing ends of the front portion, and a recessed area on an upper side of the body and disposed along a rear edge of a rear portion of the body. The upper denture sponge is configured to conform to an upper surface of a plate of an upper denture.

A method of using the denture aid system includes inserting the lower denture sponge into the plate of the lower denture, installing the lower denture such that the lower denture sponge compresses against a gumline and suctions to a lower palate of the mouth, inserting the upper denture sponge into the plate of the upper denture, and installing the upper denture such that the upper denture sponge compresses against a gumline and suctions to an upper palate of the mouth, In this way, the denture aid system can be utilized without the need for additional adhesives, powders, or other materials.

One object of the present invention is to provide a denture aid system that enables denture users to chew food, drink liquids, and speak cohesively and comfortably without denture slippage or gum pain.

Another object of the present invention is to provide a denture aid system including upper and lower denture sponges that expand to conform to a denture plate and to replace lost bone and root volume within the wearer's jaw and mouth.

A further object of the present invention is to provide a denture aid system with upper and lower denture sponges that can be worn for up to twenty-four hours and can be easily cleaned and reused.

Yet another object of the present invention is to provide a denture aid system with denture sponges that when placed along the extracted teeth gumline provides a balm for the gum's soreness without the need for additional powders, salves, or other substances.

Still a further object of the present invention is to provide a denture aid system with upper and lower denture sponges specifically designed for use with the upper and lower dentures, such that the different sponges accommodate the different construction of the upper and lower dentures.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the lower denture sponge from an embodiment of the denture aid system.

FIG. 2 shows a perspective view of the upper denture sponge from an embodiment of the denture aid system.

FIG. 3 shows a bottom plan view of a lower denture plate.

FIG. 4 shows a top perspective view of an upper denture plate.

FIG. 5 shows a top plan view of the upper denture plate with the upper denture sponge of the denture aid system installed.

### DETAILED DESCRIPTION OF THE INVENTION

Reference is made herein to the attached drawings. Like reference numerals are used throughout the drawings to depict like or similar elements of the denture aid system and method. For the purposes of presenting a brief and clear description of the present invention, the preferred embodiment will be discussed as used for providing a pair of denture sponges that together provide an improved, comfortable fit for a pair of upper and lower hard-sided dentures. Additionally, the figures are intended for representative purposes only and should not be considered to be limiting in any respect.

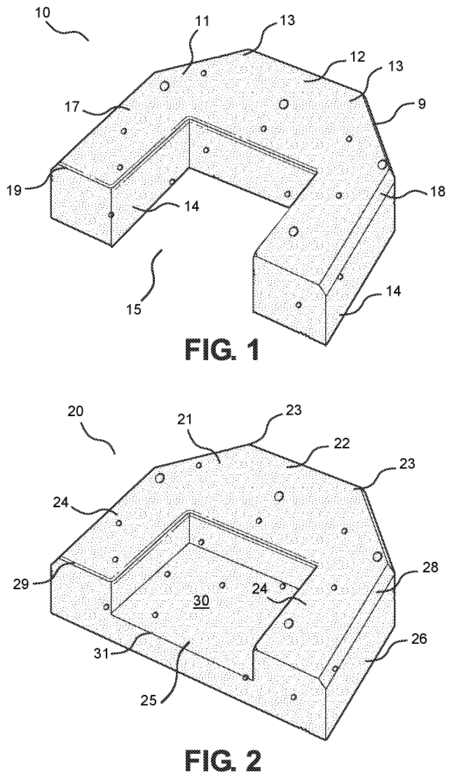

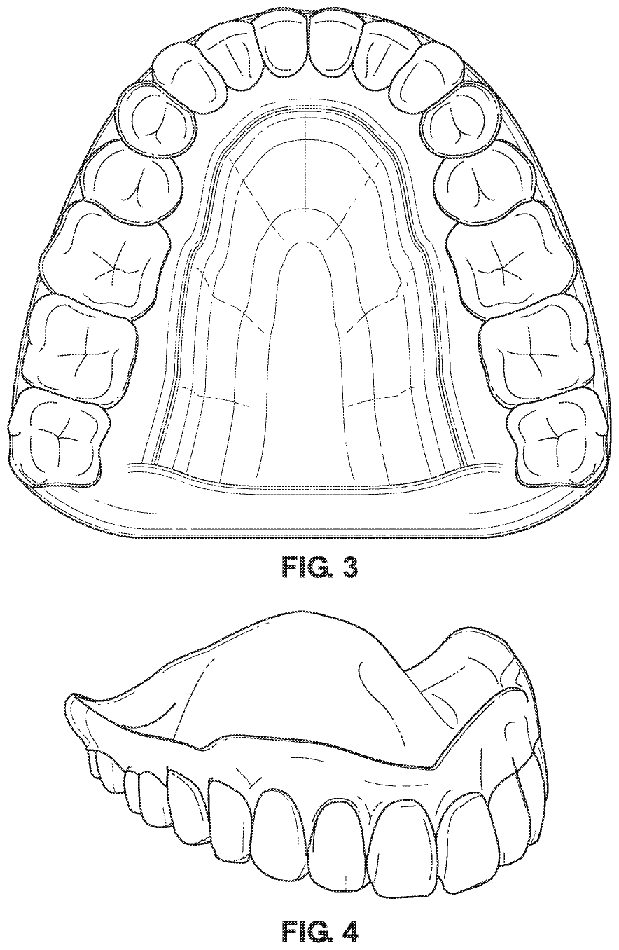

Referring now to FIGS. 1 and 2, there are shown a perspective views of the lower denture sponge and the upper denture sponge from an embodiment of the denture aid system. As shown in FIG. 1, the lower denture sponge 10 comprises a body 13 having a front portion 12. A pair of arm portions 13 extend rearwardly from opposing ends 12 of the front portion 11. A rear opening IS extends through a rear edge 19 of the body 11 toward the front portion. The body 11, pair of arm portions 13, and rear opening 15 define a general U-shape to the lower denture sponge 10, which allows it to better conform to the shape of the lower denture. The lower denture sponge is formed from a compressible, expandable, absorbent, and porous polyurethane material, in this way, the lower denture sponge is configured to conform to an inner surface of a plate of a lower denture, an example of which is shown in FIG. 3.

As shown in FIG. 2, the upper denture sponge 20 is similar yet slightly different in shape and structure to the lower denture sponge 10. In the shown embodiment, the upper denture sponge 20 includes a body 21 having a front portion 22, a pair of arm portions 24 extending rearwardly from opposing ends 23 of the front portion 22, and a recessed area 25 extending into an upper side 27 of the body 21 and disposed along a rear edge 29 of a rear portion of the body 21, such that the recessed area 25 defines the space of separation between the arm portions 24. The recessed area 25 is configured to receive and conform to the raised upper portion 43 within the interior portion or plate 42 of the upper denture 40, which is shown in FIG. 4 for example purposes. In this way, the upper denture sponge 20 is configured to conform to the plate 42 of the upper denture 40.

In the shown embodiments, the upper and lower denture sponges 10, 20 include upper and lower planar surfaces that intersect at a ninety-degree or perpendicular angle with planar sidewalls, defining a general polygonal structure. In the shown embodiment, the bodies 11, 21 of the lower and upper denture sponge 10, 20 includes a pair of beveled or angled sidewalls 9, 31 where the arm portions 14, 24 join with the opposing ends 13, 23 of the front portions 12, 22. This shape helps the lower and upper denture sponges 10, 20 conform to the shape of the lower and upper dentures. In one embodiment, the overall height 16 of the lower denture sponge 10 and the overall height 26 of the upper denture sponge 20 is equal to three centimeters. This height helps to provide a universal fit to different sizes and types of dentures while providing enough material to cushion and improve the comfort of the dentures when they are worn.

While a generally rectangular shape is desired to improve the fit to the denture, some variation to the edges may be included. For example, in the shown embodiment, the body 11 of the lower denture sponge 10 includes an upper beveled edge 18. The upper beveled edge 18 is configured to contact and conform to the upper surface of the lower denture for an improved fit and better sealing properties. The body 12 of the upper denture sponge 11 includes a similar upper beveled edge 28 with similar fitting properties.

In one embodiment, the upper and lower denture aids have specified dimensions designed to provide a comfortable yet. universal fit with different types and sizes of denture appliances. For example, in one embodiment, the upper beveled edges 18, 28 include a width equal to one-half centimeters. This size is ideal to establish continuous contact along the inner surface of the denture plate. Further, in the shown embodiment, the rear edges 19, 29 of the upper and lower denture sponges 20, 10 are straight, or perpendicular without a bevel. This improves the fit within the mouth of the wearer as the arms portions 14, 24 conform to the curving shape of the denture toward the rear molars. The body 21 of the upper denture sponge 20 includes a recessed area 25 with a planar upper surface that creates a better suction when adhering the denture plate to the wearer's gumline. The perpendicular rear edge of the recessed area 25 also helps to ensure a proper fit as the sponge material expands to fill the inner parts of the denture plates and to fill empty volume within the mouth and jaw of the user that remain when teeth and other tissue are removed.

In use, the upper and lower denture sponges are first placed inside the denture plate of the respective upper and lower dentures. The method includes inserting the lower denture sponge into the plate of the lower denture, installing the lower denture such that the lower denture sponge compresses against a gumline and suctions to a lower palate of the mouth, inserting the upper denture sponge into the plate of the upper denture, and installing the upper denture such that the upper denture sponge compresses against a gumline and suctions to an upper palate of the mouth.

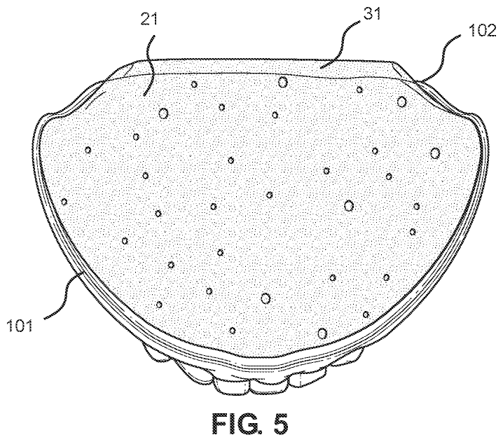

When installed, the sponge material expands to fictionally engage the interior walls of the upper and lower denture plates. Once the sponges are installed, the upper and lower dentures are placed onto the wearer's upper and lower gums. The upper and lower denture sponges, along with the moisture within the wearer's mouth, help to apply additional suction force for better securement of the upper and lower dentures. As shown in FIG. 5, the rear edge 31 of the upper denture sponge 21 extends outwardly at an angle from a rear edge 102 of the upper denture plate 101 when secured thereto, thereby creating further suction for the upper denture plate 101 when installed. The same process may occur with the lower denture plate. Once installed, the upper denture sponge 21 fits flush along the rear of the plate as the suction force compresses the upper denture sponge 21 between the upper denture 101 and the upper palette. This provides additional suction force that creates a better seal between the denture and the gums, preventing food particles from entering and potentially causing harm. The denture aid system can be use daily or sporadically as needed by the user. In this way, the denture sponges provide an improved, comfortable fit for the wearer.

The upper and lower denture aids are formed of a sponge material. The material is absorbent and compressible such that it expands to fit to a space, allowing it to frictionally engage the denture plate for securement thereto when in use. In one embodiment, the composition of the upper and lower denture sponges includes an opaque, porous, polyurethane-based material. This material can expand to occupy any empty space within the mouth and jaw area. Such empty space is typically formed when a user has teeth or other tissue removed from the mouth or jaw. Unlike a typical adhesive strip, the thicker, compressible, and expandable sponge material expands to fill these volumes.

The upper and lower denture sponges may be stored within a sterile solution when not in use. For example, the upper and lower denture sponges may be stored in hydrogen peroxide along with the upper and lower dentures when not in use. In one embodiment, the upper and lower denture sponges are designed to be useable for up to three days. The denture sponge material also helps to collect and absorb any unwanted material that does get into the denture attachment area. For example, after the individual eats, or when the dentures are not being worn, an individual can rinse the denture sponges with hydrogen peroxide, water, or other materials to remove any buildup or absorbed material from the sponges, and then reinstall them for reuse.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those Illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A denture aid system, comprising:
a lower denture sponge comprising a body having a front portion, a pair of arm portions extending rearwardly from opposing ends of the front portion, and a rear opening extending into a rear portion of the body;
wherein the lower denture sponge is configured to conform to an inner surface of a plate of a lower denture;
an upper denture sponge comprising a body having a front portion, a pair of arm portions extending rearwardly from opposing ends of the front portion, and a recessed area on an upper side of the body and disposed along a rear edge of a rear portion of the body;
wherein the upper denture sponge is configured to conform to an upper surface of a plate of an upper denture.

2. The denture aid system of claim 1, wherein the body of the lower denture sponge comprises upper and lower planar surfaces that intersect with a plurality of planar sidewalls.

3. The denture aid system of claim 1, wherein the body of the upper denture sponge comprises upper and lower planar surfaces that intersect with a plurality of planar sidewalls.

4. The denture aid system of claim 1, wherein the body of the lower denture sponge includes a pair of beveled sidewalls where the arm portions join with the opposing ends of the front portion.

5. The denture aid system of claim 1, wherein the body of the upper denture sponge includes a pair of beveled sidewalls where the arm portions join with the opposing ends of the front portion.

6. The denture aid system of claim 1, wherein the body of the lower denture sponge includes an upper beveled edge, wherein the upper beveled edge is configured to contact and conform to the upper surface of the lower denture.

7. The denture aid system of claim 6, wherein the upper beveled edge terminates at rear edges of the arm portions of the lower denture sponge, wherein the rear edges of the arm portions of the lower denture sponge include a perpendicular edge.

8. The denture aid system of claim 6, wherein the upper beveled edge of the lower denture sponge includes a width equal to one-half centimeters.

9. The denture aid system of claim 1, wherein the body of the upper denture sponge includes an upper beveled edge, wherein the upper beveled edge is configured to contact and conform to the upper surface of the upper denture.

10. The denture aid system of claim 9, wherein the upper beveled edge terminates at rear edges of the arm portions of the upper denture sponge, wherein the rear edges of the arm portions of the upper denture sponge include a perpendicular edge.

11. The denture aid system of claim 9, wherein the recessed area of the upper denture sponge includes a planar upper surface.

12. The denture aid system of claim 9, wherein the recessed area of the upper denture sponge includes a perpendicular rear edge.

13. The denture aid system of claim 9, wherein the recessed area of the upper denture sponge includes a height equal to one and one-half centimeters.

14. The denture aid system of claim 9, wherein the upper beveled edge of the upper denture sponge includes a width equal to one-half centimeters.

15. The denture aid system of claim 14, wherein the body of the upper denture sponge and the body of the lower denture sponge each includes a maximum height of three centimeters.

16. The denture aid system of claim 14, wherein a rear edge of the upper denture sponge extends outwardly at an angle from a rear edge of the upper denture plate when secured thereto, thereby creating further suction for the upper denture plate when installed.

17. A method of using a denture aid system, comprising:
providing a lower upper denture sponge comprising a body having a front portion, a pair of arm portions extending rearwardly from opposing ends of the front portion, and a rear opening extending into a rear portion of the body, wherein the lower denture sponge is configured to conform to an inner surface of a plate of a lower denture;
providing an upper denture sponge comprising a body having a front portion, a pair of arm portions extending rearwardly from opposing ends of the front portion, and a recessed area on an upper side of the body and disposed along a rear edge of a rear portion of the body, wherein the upper denture sponge is configured to conform to an upper surface of a plate of an upper denture;
inserting the lower denture sponge into the plate of the lower denture;
installing the lower denture such that the lower denture sponge compresses against a gumline and suctions to a lower palate of the mouth;
inserting the upper denture sponge into the plate of the upper denture; and
installing the upper denture such that the upper denture sponge compresses against a gumline and suctions to an upper palate of the mouth.
